(19) United States
(12) Patent Application Publication
(10) Pub. No.: US 2024/0333327 A1
(43) Pub. Date: Oct. 3, 2024

(54) ACCESS POINT OF A CELL-FREE AND DISTRIBUTED MASSIVE MIMO NETWORK, NETWORK AND METHOD FOR LIMITING SIGNAL DISTORTION CAUSED BY ACCESS POINT HARDWARE IMPAIRMENTS

(71) Applicant: Commissariat à l'énergie atomique et aux énergies alternatives, Paris (FR)

(72) Inventor: Rafik ZAYANI, Grenoble Cedex 9 (FR)

(73) Assignee: Commissariat à l'énergie atomique et aux énergies alternatives, Paris (FR)

(21) Appl. No.: 18/623,101

(22) Filed: Apr. 1, 2024

(30) Foreign Application Priority Data
Apr. 3, 2023 (FR) 23 03280

(51) Int. Cl. H04B 1/12; H04B 1/04; H04B 1/10; H04W 88/08

(52) U.S. Cl. CPC H04B 1/12; H04B 1/0475; H04B 1/109; H04W 88/08

(57) ABSTRACT

The invention relates to such an access point (10) comprising:
a determination module (12) for determining a signal distortion caused by the own hardware impairments thereof,
a transmission module (14), via a fronthaul link comprising a plurality of access points in series, ordered along a predetermined direction of travel to the central unit of a base station, of said distortion to another access point, or to the central unit, following it within said fronthaul bond; and/or
a reception module (16) for receiving and taking into account said distortion of an access point preceding it within said fronthaul link, so as to determine the local precoding filters of said access point configured to cancel said distortion of said access point preceding it.

### CROSS-REFERENCE TO RELATED APPLICATIONS

This application is a U.S. non-provisional application claiming the benefit of French Application No. 23 03280, filed on Apr. 3, 2023, which is incorporated herein by reference in its entirety.

### FIELD

The present invention relates to an access point of a cell-free distributed massive MIMO network.

The invention further relates to such a cell-free distributed massive MIMO network.

The invention further relates to a method of limiting signal distortion caused by hardware impairments of a plurality of access points of a fronthaul link of a cell-free distributed massive MIMO network.

The invention further relates to a computer program comprising software instructions which, when executed by a computer, implement such a method of limiting signal distortion caused by hardware impairments of a plurality of access points of a fronthaul link of a cell-free distributed massive MIMO network.

### BACKGROUND

The present invention relates, in a general way, to the field of wireless communications systems, and more particularly to data transmission via the use of a radio frequency signal using multi-carrier modulation, in particular OFDM (Orthogonal Frequency Division Multiplexing) according to a downlink communication channel corresponding to the communication between access points and users.

Telecommunication systems using multi-carrier modulation for the downlink communication channel are well known in the prior art. The principle of such modulation consists in dividing the transmission band into a plurality of frequency sub-channels associated with carriers and in modulating each of the carriers by the data to be transmitted on said downlink communication channel, also called, hereinafter, a downlink channel.

More precisely, the present invention belongs to the framework of a cell-free, distributed massive MIMO (Multiple-Input Multiple-Output) network architecture, or CF-mMIMO (cell-free massive MIMO) as introduced in particular in the article by S. Buzzi et al. entitled “Cell-free massive mimo: User-centric approach” published in IEEE Wireless Communications Letters, vol. 6, no. 6, pp. 706-709, 2017. Such a cell-free distributed massive MIMO network architecture has been proposed to address the exponential growth of mobile data traffic and the problems of inter-cell interference and excessive variation in quality of service, to meet the challenges of the sixth generation of mobile communications, 6G.

Such a cell-free distributed massive MIMO network architecture is composed of a large number of geographically distributed access points (APs), which jointly serve the user terminals along said downlink channel, or UE (User Equipment), which guarantees a gain in macro-diversity and provides good spectral efficiency (SE), uniformly good in the coverage area.

Such telecommunication systems based on such a cell-free distributed massive MIMO network architecture can only be commercially advantageous if the APs are deployed using inexpensive hardware with low power consumption. Therefore, severe hardware impairments (HWIs), may occur when transmitting radio frequency signals using multi-carrier modulation, including OFDM with a high peak-to-average power ratio (PAPR), which results in poor transmission quality.

### SUMMARY

The goal of the present invention is thus to propose a solution for effectively limiting the effect of such hardware impairments in order to make cost and energy efficient deployments of access points possible within such cell-free distributed massive MIMO networks and provide energy efficient communications.

To this end, the invention relates to an access point of a cell-free distributed massive MIMO network comprising at least:
a determination module configured to determine an information item representative of signal distortion caused by the own hardware impairments of said access point,
a transmission module configured to transmit, via a fronthaul link comprising a plurality of access points in series, ordered along a predetermined direction of travel of said fronthaul link to the central unit of a base station, said information item representative of said signal distortion to another access point, or to the central unit, directly following it within said fronthaul link; and/or
a reception module configured to receive, via said fronthaul link, said information item representative of a signal distortion caused by the hardware impairments of an access point directly preceding it within said fronthaul link, and to take into account the information item so as to determine the local precoding filters of said access point configured to cancel said signal distortion caused by the hardware impairments of said access point preceding it.

According to one particular case, the invention relates to an access point of a cell-free distributed massive MIMO network comprising at least:
a determination module configured to determine an information item representative of signal distortion caused by the own hardware impairments of said access point,
a transmission module configured to transmit, via a fronthaul link comprising a plurality of access points in series, ordered along a predetermined direction of travel of said fronthaul link to the central unit of a base station, said information item representative of said signal distortion to another access point, or to the central unit, directly following it within said fronthaul link;
a reception module configured to receive, via said fronthaul link, an information item representative of a signal distortion caused by the hardware impairments of an access point directly preceding it within said fronthaul link, and to take into account the information item so as to determine the local precoding filters of said access point configured to cancel said signal distortion caused by the hardware impairments of said access point preceding it.

The present invention thereby aims to take advantage of each fronthaul link connecting in series a plurality of access points to the central unit of the base station, in other words, the fronthaul link corresponding, by definition according to the present invention, to the interconnection link of the access points with the central unit, in order to correct step-by-step via said fronthaul link for signal distortion caused by hardware impairments of each access point when implementing communication on the downlink communication channel of the cell-free distributed massive MIMO network, each access point being configured to cancel the distortion caused by hardware impairments of the preceding access point within said fronthaul link, and so on, from the farthest access point to the central unit of the base station, along a predetermined direction of travel of said fronthaul link.

According to other advantageous aspects of the invention, the access point of a cell-free, distributed massive MIMO comprises one or a plurality of the following features, taken individually or according to all technically possible combinations:
in order to determine said information item representative of signal distortion, said determination module for determining the access point is configured to:
   obtain a local estimation of the propagation channel between each of the transmitters thereof and each user terminal within the range thereof within said cell-free distributed massive MIMO network,
   determine the power allocated to each data signal suitable for being transmitted between that access point and each user terminal within the range thereof within said cell-free distributed massive MIMO network,
   precode each data signal suitable for being transmitted between each of the transmitters thereof and each user terminal within the range thereof within said cell-free distributed massive MIMO network based on said associated local estimation and on said allocated power;
   transmit each precoded signal as input to a hardware model of the transmission chain of the associated transmitter thereof;
   determine said information item representative of the signal distortion caused by the own hardware impairments of the transmitter, by comparing the output of said hardware model and said input precoded signal;
said hardware model of the transmission chain of each transmitter is modeled using at least one predetermined measurement and/or a predetermined optimization;
said access point comprises a plurality of simultaneously active transmitters, said information item representative of a signal distortion caused by the own hardware impairments corresponding to the concatenation of the signal distortion caused by the own hardware impairments of each of the transmitters of said plurality;
each transmitter is an OFDM transmitter;
each local precoding filter is an MRT, FZF or RZF filter.

A further subject matter of the invention is a central unit of a base station of a cell-free distributed massive MIMO network, said central unit being associated with at least one fronthaul link comprising a plurality of said access points in series and ordered along a predetermined direction of travel of said fronthaul link to said central unit,
said central unit of base station comprising at least one reception module configured to receive, via said fronthaul link, an information item representative of signal distortion caused by hardware impairments of an access point directly preceding it within said fronthaul link, and to take into account said information item so as to determine the local precoding filters of said central unit configured to cancel said signal distortion caused by the hardware impairments of said access point preceding it

A further subject matter of the invention is a cell-free distributed massive MIMO network comprising at least one fronthaul link, said at least one fronthaul link comprising a plurality of access points in series according to the invention as described hereinabove and ordered along a predetermined direction of travel of said fronthaul link.

A further subject matter of the invention is a method of limiting the signal distortion caused by hardware impairments of a plurality of access points of a fronthaul link of a cell-free distributed massive MIMO network, said plurality of access points being connected in series along said fronthaul link to the central unit of a base station and ordered along a predetermined direction of travel of said fronthaul link, said method being implemented by each access point of said fronthaul link or by said central unit, and implemented during the communication on the downlink communication path of said cell-free distributed massive MIMO network, said method comprising at least the following steps:
determination of an information item representative of a signal distortion caused by the own hardware impairments of said access point, and/or
transmission, via said fronthaul link, of said information item representative of said signal distortion caused to another access point, or to the central unit of a base station, directly following it within a fronthaul link comprising a plurality of access points in series, ordered along a predetermined direction of travel of said fronthaul link; and/or
reception, via said fronthaul link, and taking into account said information item representative of a signal distortion caused by the hardware impairments of an access point directly preceding it within said fronthaul link so as to determine the local precoding filters of said access point or of said central unit configured to cancel said distortion signal caused by hardware impairments of the access point preceding it.

According to one particular case, the invention provides a method of limiting the signal distortion caused by hardware impairments of a plurality of access points of a fronthaul link of a cell-free distributed massive MIMO network, said plurality of access points being connected in series along said fronthaul link to the central unit of a base station and ordered along a predetermined direction of travel of said fronthaul link, said method being implemented by each access point of said fronthaul link or by said central unit, and implemented during the communication on the downlink communication channel of said cell-free distributed massive MIMO network, said method comprising at least the following steps:
determination of an information item representative of a signal distortion caused by the own hardware impairments of the access point, and
transmission, via said fronthaul link, of said information item representative of said signal distortion caused to another access point, or to the central unit of a base station, directly following it within a fronthaul link comprising a plurality of access points in series ordered along a predetermined direction of travel of said fronthaul link;
   or:
determination of an information item representative of a signal distortion caused by the own hardware impairments of the access point, and
transmission, via said fronthaul link, of said information item representative of said signal distortion caused to another access point, or to the central unit of a base station, directly following it within a fronthaul link comprising a plurality of access points in series, ordered along a predetermined direction of travel of said fronthaul link; and
reception, via said fronthaul link, and taking into account of an information item representative of a signal distortion caused by hardware impairments of an access point directly preceding it within said fronthaul link, so as to determine the local precoding filters of said access point or of said central unit configured to cancel said signal distortion caused by the hardware impairments of said access point preceding it,
   or:
reception, via said fronthaul link, and taking into account an information item representative of a signal distortion caused by the hardware impairments of an access point directly preceding it within said fronthaul link so as to determine the local precoding filters of said access point or of said central unit configured to cancel said distortion signal caused by hardware impairments of the access point preceding it.

According to an advantageous optional aspect of the method according to the invention, said determination of an information item representative of a signal distortion caused by the own hardware impairments of said access point comprises:
obtaining a local estimate of the propagation channel between each of the transmitters thereof and each user terminal within the range thereof within the said cell-free distributed massive MIMO network,
the determination of the power allocated to each data signal suitable for being transmitted between said access point and each user terminal within the range thereof within said cell-free distributed massive MIMO network,
the precoding of each data signal suitable for being transmitted between each of the transmitters thereof and each user terminal within the range thereof within said cell-free distributed massive MIMO network based on said associated local estimation and allocated power;
the transmission of each precoded signal at the input of a hardware model of the transmission chain of the associated transmitter thereof;
the determination of said information item representative of the signal distortion caused by the own hardware impairments of the transmitter, by comparing the output of said hardware model and said input precoded signal.

A further subject matter of the invention is a computer program comprising software instructions which, when executed by a computer, implement such a method of limiting signal distortion caused by hardware impairments of a plurality of access points of a fronthaul link of a cell-free distributed massive MIMO network, such as defined hereinabove.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic representation of an access point according to the invention;

FIG. 2 shows an example of a hardware architecture of a part of the access point shown schematically in FIG. 1;

FIG. 3 is a schematic representation of two embodiments of a fronthaul link of a cell-free distributed massive MIMO network and of the role played by each of the plurality of access points in series that compose same;

FIG. 4 is a flowchart of the method of limiting the signal distortion caused by hardware impairments of a plurality of access points in a fronthaul link of a cell-free distributed massive MIMO network.

### DETAILED DESCRIPTION

It should be noted that thereafter, the following conventions of mathematical notations are used, namely:
matrices are denoted by bold capital letters, e.g. X
vectors are denoted by lowercase letters in bold, e.g. x,
a transpose of a matrix, a conjugate transpose of a matrix conjugate, a pseudo-inverse matrix and the trace of a matrix are denoted by X^{T}, X^{H}, X† and tr(X) respectively,
for a matrix of dimension M×N, the notation X={xₘₙ} is used, with xₙ for denoting the n^{th} column, and xₘ^{t} for denoting the m^{th} row,
the identity matrix N×N and the all-zeros matrix M×N are denoted by I_{N} and 0_{M×N}, respectively,
the notation X=diag{x₁, . . . , xₖ} refers to a diagonal matrix with elements {xᵢ},
E [.] represents the hope operator,! is the factorial operator and j represents VET.

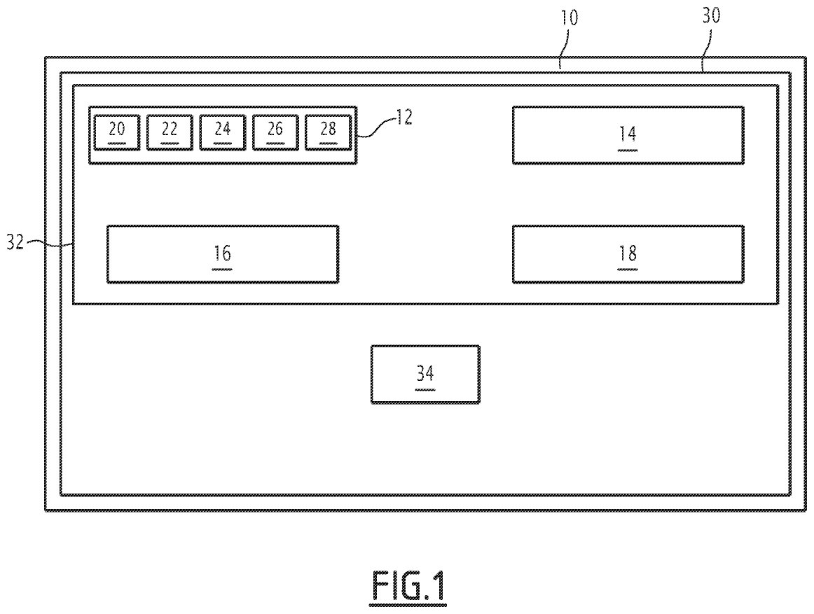

FIG. 1 first of all illustrates schematically, an access point 10 of a cell-free distributed massive MIMO network according to the present invention.

According to the present invention, such an access point 10 of a cell-free distributed massive MIMO network first of all comprises a determination module 12 configured to determine an information item representative of a signal distortion caused by the own hardware impairments of said access point 10.

In addition, the access point 10 according to the present invention comprises a transmission module 14 configured to transmit, via a fronthaul link comprising a plurality of access points in series, ordered along a predetermined direction of travel of said fronthaul link to the central unit, said information item representative of said signal distortion to another access point, or to the central unit of a base station, directly following it within said fronthaul link.

Furthermore, the access point 10 according to the present invention further comprises a reception module 16 configured to receive, via said fronthaul link, said information item representative of a signal distortion caused by the hardware impairments of an access point directly preceding it within said fronthaul link, and to take the information item so as to determine the local precoding filters of said access point configured to cancel said signal distortion caused by the hardware impairments of said access point preceding it.

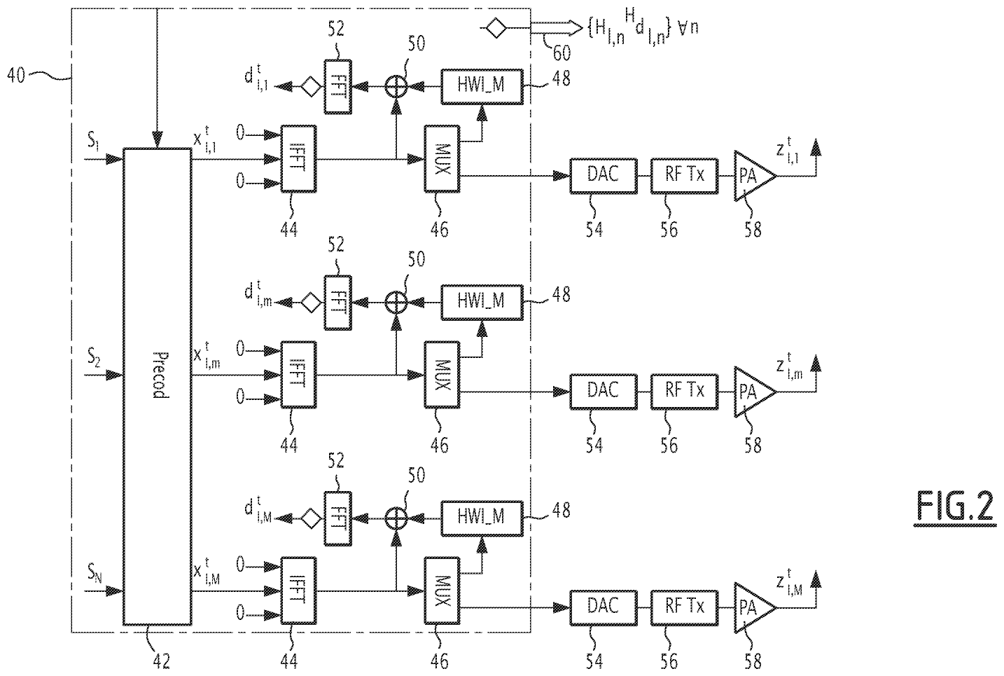

In addition, the access point 10 conventionally comprises a set 18 of electronic modules dedicated to conventional processing implemented conventionally by an access point of a cell-free distributed massive MIMO network such as e.g. a channel estimation module configured to estimate the channel, a first precoding module configured to calculate the local precoding filters (i.e. conventionally without worrying about signal distortion caused by the hardware impairments of the preceding access point), a second precoding module configured to precode each of the data vectors suitable for being transmitted to a user by applying said local precoding filters, electronic elements of the radio interface configured to transmit, by radio, the precoded data via said precoding filters to the users, etc., such elements being described thereafter in relation to FIG. 2 [which] illustrates an example of a hardware architecture of a part of the access point shown schematically in FIG. 1.

An example of a determination module 12 such as represented by FIG. 1 is described hereinafter in greater detail.

Indeed, according to the embodiment illustrated in FIG. 1, the determination module 12 comprises e.g. the elements 20, 22, 24, 26 and 28.

The element 20 is configured, in particular, to obtain a local estimation of the propagation channel between each of the transmitters (not shown in FIG. 1) of the access point 10 and each user terminal within the range thereof within said cell-free distributed massive MIMO network.

Such a local channel estimation is implemented in particular by a channel estimation module of the set 18 and the element 20 recovers each channel estimation between each of the transmitters (not shown in FIG. 1) of access point 10 and each user terminal within the range thereof within said cell-free distributed massive MIMO network.

The element 22 is configured to determine the power allocated to each data signal suitable for being transmitted between said access point and each user terminal within the range thereof within said cell-free distributed massive MIMO network.

The element 24 is configured to precode each data signal suitable for being transmitted between each of the transmitters of the access point 10 and each user terminal within the range thereof within said cell-free distributed massive MIMO network, based on said associated local estimation and said allocated power.

The element 26 is configured to transmit each precoded signal at the input of a hardware model of the transmission chain of the associated transmitter thereof (i.e. associated with said precoded signal).

The element 28 is configured to determine said information item representative of the signal distortion caused by the own hardware impairments of said transmitter by comparing the output of said hardware model and said input precoded signal.

According to a variant illustrated as an example in FIG. 1, the access point 10 further comprises a processing unit 30 formed e.g. by a memory 32 and a processor 34 associated with the memory 32, and the access point 10 is at least partly implemented in the form of a software, or of a software brick, executable by the processor, in particular the determination module 12, the transmission module 14, the reception module 16, and one or a plurality of electronic modules of the set 18 of electronic modules dedicated to conventional processing implemented conventionally by an access point of a cell-free distributed massive MIMO network. The memory 32 of the access point 10 is then apt to store such software or software bricks, and the processor 34 is then apt to execute same.

In a variant (not shown), the reception module 12, the transmission module 14, the reception module 16, and one or a plurality of electronic modules of the set 18 of electronic modules dedicated to conventional processing usually implemented by an access point of a cell-free, distributed massive MIMO are each produced in the form of a programmable logic component, such as an FPGA (Field Programmable Gate Array), or further in the form of a dedicated integrated circuit, such as an ASIC (Application Specific Integrated Circuit).

When at least a part of the access point 10 according to the invention is produced in the form of one or a plurality of software programs, i.e. in the form of a computer program, such part is further apt to be stored on a computer-readable medium (not shown). The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or further an optical card. A computer program containing software instructions is then stored on the readable medium.

FIG. 2 illustrates a non-limiting example of a hardware architecture of a part of the access point represented schematically in FIG. 1, in particular in the case where it is considered useful to implement cell-free distributed massive MIMO networks, using in particular multi-carrier modulation, in particular OFDM, such networks being known by the abbreviated name CF-mMIMO-OFDM.

According to such example, N modulated input signals s₁ to s_{N}, are considered, N being an integer corresponding to the number of OFDM subcarriers, at the input of a set 40 of electronic modules for digital signal processing.

The information data to be transmitted to K users on the n^{th} subcarrier denoted by means of the signal Sₙ such as sₙ∈ [symbol] ^{K×1} comprise independent elements of unit power, such as E{∥sₙ∥²}=1.

It should be noted that OFDM systems conventionally define a guard band of unused subcarriers, located at each end of the spectral band used. Thereby, the set of available subcarriers is divided into two complementary sets, one used for data transmission and the complementary set thereof used for the guard band wherein no data is transmitted.

More particularly, thereafter, the response of the channel in the frequency domain between the l^{th} access point and the user k on the n^{th} subcarrier with n=0, . . . , N−1, is denoted by h_{l,k,n}ϵ [symbol] ^{M×1}. The channels are modeled using the independent Rayleigh fading, i.e. each channel h_{l,k,n}˜CN(0,β_{l,k}I_{M}), where β_{l,k} is the large-scale fading coefficient between the l^{th} access point AP and the k^{th} UE (User Equipment), independent of the antennas or of the subcarriers used.

In addition, thereafter, block fading channels are considered, which are constant during a time-frequency interval, known as a coherence time, and which vary independently between the coherence times.

Furthermore, it is also assumed later that the large-scale fading coefficients vary slowly, within a range of several coherence intervals, which makes it obvious to consider that the channel gains are known a priori at each access point and are used to estimate the current channel responses.

The set 40 of electronic modules is organized into M digital signal processing chains associated with each of said M transmitters of the access point 10 considered, each transmitter optionally being an OFDM transmitter.

Such an assembly 40 comprises, in particular, in the example of digital architecture shown in FIG. 2, a precoding module 42 suitable for implementing distributed linear local precoding.

More precisely, the precoding implemented by the precoding module 42 is needed for being used at each access point in order to eliminate the multi-user interference (MUI) at the receivers. Within CF-mMIMO-OFDM networks, the local nature of the precoders (i.e. precoding module 42) is crucial for preserving a system scalability (a scalable network being a network the computational complexity of which remains finite by geographically extending the network and by increasing the number of users); for this reason, the notion of “local precoding” (i.e. locally within the access point) is used thereafter.

More precisely, thereafter, an implementation distributed by the precoding module 42 of each access point is considered, without sharing any information between access points, and, at the precoding module 42 as such, without worrying about signal distortion caused by hardware impairments of the access point preceding the current access point.

Each local precoding filter is an MRT (maximum ratio transmission) filter, namely the maximum ratio transmission precoding, a FZF (Full pilot zero forcing) filter, namely the zero forcing for pilots or an RZF filter—the regularized version of FZF namely the regularized zero forcing, the precoded vector in the frequency domain suitable for being transmitted by the access point with index l on the subcarrier with index n being expressed in the following form:

$${x}_{l , n} = {W}_{l , n} {P}_{l} {s}_{n} \qquad ( 1 )$$

W_{l,n}ϵ [symbol] ^{M×K} is the precoding matrix associated with the n-index subcarrier for the access point of index l,
Pₗϵ [symbol] ^{K×K}, which is frequency independent, represents a diagonal matrix the elements \sqrt{n_{l,k}} of which, such that k=1, . . . , K are the normalized transmission powers allocated to the K users.
sₙϵ [symbol] ^{K×1} is the data vector to be transmitted to the K users on the subcarrier n.

More precisely, the precoding vector w_{l,n,k}ϵ [symbol] ^{M×1} used by the l^{th} access point toward the k^{th} user on the subcarrier n is expressed in the form:

$${w}_{l , n , k} = \{ \begin{matrix}{{\hat{H}}_{l , n} ( {\hat{H}}_{l , n}^{H} {\hat{H}}_{l , n} )}^{- 1} {C}_{l} {e}_{k} , & for local FZF filtering \\ {{\hat{H}}_{l , n} ( {\hat{H}}_{l , n}^{H} {\hat{H}}_{l , n} + {P}_{l}^{- 1} )}^{- 1} {C}_{l} {e}_{k} , & for local RZF filtering\end{matrix} \qquad ( 2 )$$

where:
Cₗϵ [symbol] [symbol] K×K is a normalization matrix satisfying {E{∥w_{l,n,k}∥²}=1, ∀k},
Ĥ_{l,n}ϵ [symbol] ^{M×K} Is the channel estimation matrix between the access point of index l (i.e. the l^{th} access point) and the K users on the subcarrier n, which can also be in the form: Ĥ_{l,n}=[ĥ_{l,n,1}, . . . , ĥ_{l,n,K}], and represented by the incoming vertical downward arrow in the precoding module 42, considering in particular, frequency selective channels, the channel estimation indeed being implemented locally at each access point in order to preserve the scalability of the network, the reason why the local minimum mean-squared error (MMSE) of channel estimation ĥ_{l,k,n} of the channel h_{l,k,n} is suitable for being calculated as described by G. Interdonato et al. in the article “Local Partial Zero-Forcing Precoding for Cell-Free Massive MIMO” IEEE Transactions on Wireless Communications, vol. 19, no. 7, pp. 4758-4774, 2020 with the pilot transmission on the uplink.
Pₗϵ [symbol] ^{K×K} is a diagonal regularization matrix,
eₖ Is the k^{th} column of the identity matrix Iₖ, which subsequently amounts to taking the k^{th} column of Ĥ_{l,n}(Ĥ_{l,n}^{H}Ĥ_{l,n})⁻¹Cₗ.

It should be noted that, conventionally, the precoding schemes are known to a person skilled in the art as described in particular by G. Interdonato et al. in the article “Local Partial Zero-Forcing Precoding for Cell-Free Massive MIMO” IEEE Transactions on Wireless Communications, vol. 19, no. 7, pp. 4758-4774, 2020, reason why such diagrams are not further discussed in detail thereafter, as being known and are not being as such, the subject matter of the invention.

As illustrated in FIG. 2, at the output of the precoding module 42, M radio frequency transmission chains are implemented, each chain being associated with a distinct transmitter, in particular an OFDM transmitter.

More particularly, each chain conventionally comprises, first of all, at the output of the precoding module 42, an application module 44 for applying an Inverse Fast Fourier Transform of size M_{FFT}, such that N, the number of OFDM subcarriers, is less than or equal to the size of M_{FFT} of the Inverse Fast Fourier Transform, so that in case of strict inferiority, the inputs of the Inverse Fast Fourier Transform are completed with zeros as shown in FIG. 2.

At the output of the module 44 for applying an Inverse Fast Fourier Transform, each chain then conventionally comprises a multiplexer 46

Moreover specifically, according to the present invention, each chain is supplemented by elements 48, 50 and 52 used to determine the signal distortion caused by the hardware impairments of each transmission chain.

Indeed, each radiofrequency transmission chain further conventionally comprising a digital-to-analog (DAC) converter 54, a transmitter 56, in particular an OFDM transmitter denoted by RF Tx in FIG. 2, and a power amplifier 58, is conventionally non-linear due to hardware impairments, such as e.g. caused by low-resolution quantization or by non-linear power amplifiers.

For example, the signal transmitted by the antenna of index m of the access point of index l, is expressed in the following form:

$${z}_{l , m}^{t} = f ( {a}_{l , m}^{t} ) \qquad ( 3 )$$

where f(.) represents the non-linear operation assumed to have no memory and identical for all the antennas of all the access points of the fronthaul link considered, for reasons of simplicity applied to the modulated signals {a_{l,m}^{t}, ∀m} transmitted to each antenna of the access point through the M radio frequency transmission chains.

It should be noted that according to Bussgang's theorem as introduced by R. Price in the article entitled “A useful theorem for nonlinear devices having Gaussian inputs” IRE Transactions on Information Theory, vol. 4, no. 2, pp. 69-72, 1958, the OFDM signal in the time domain is expressed at the output of the nonlinear function by the following single decomposition:

$${z}_{l , m}^{t} = {K}_{0} {a}_{l , m}^{t} + {d}_{l , m}^{t}$$

where K₀ is a frequency independent complex gain and d_{l,m}^{t} is a distortion (i.e. a noise) of zero mean with a decorrelated variance σ_{d}² of each non-Gaussian modulated transmission signal a_{l,m}^{t}, but becoming Gaussian on the reception side after OFDM demodulation.

K₀ and σ_{d}² are the parameters of hardware impairments and are suitable for being determined analytically so that the present invention proposes to determine the associated signal distortion:
by transmitting, the modulated precoded signal of each chain, obtained at the output of the multiplexer 46, at the input of a hardware model 48 of the transmission chain in question, called HWI_M, and
by subtracting, via the element 50, the output of the hardware model 48 from the modulated precoded signal at the input of the multiplexer 46, then
by demodulating, via the application module 52 for applying an FFT (Fast Fourier Transform) to obtain the distortion expressed in the frequency domain.

As an optional addition, said hardware model 48 of the transmission chain of each transmitter is modeled using at least one predetermined measurement and/or a predetermined optimization, in particular a mathematical optimization, which serves to develop models for characterizing hardware impairments.

As an optional addition, as shown in FIG. 2, when the access point has a plurality of simultaneously active transmitters, said information item representative of a signal distortion caused by the own hardware impairments corresponding to the concatenation of the signal distortion caused by the own hardware impairments of each of the transmitters of said plurality.

In other words, for a given sample, the distortion generated by a transmitter is represented by a coefficient d_{l,m}^{t}. Consequently, the distortion generated by M emitters is a vector of dimension M comprising the M distortion coefficients generated by the M emitters.

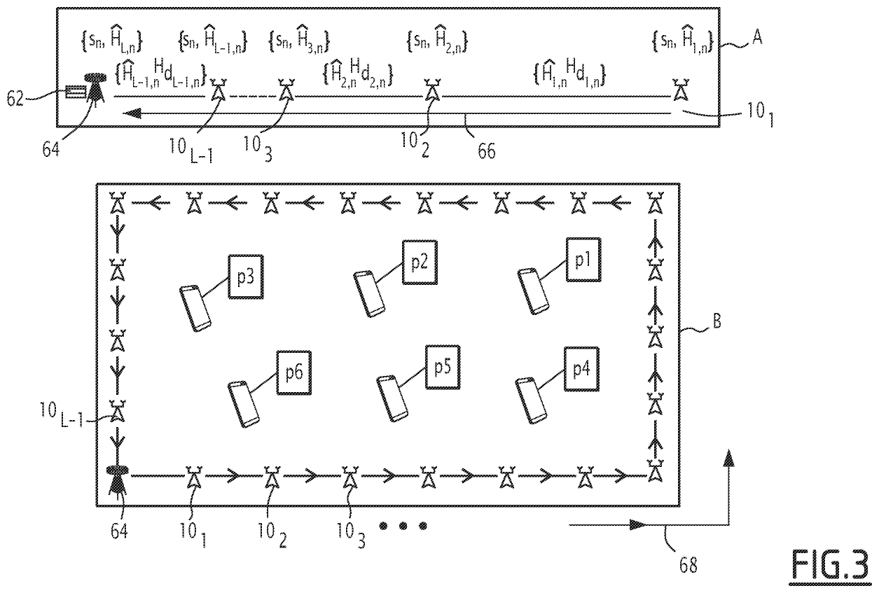

FIG. 3 is a schematic representation of two embodiments of the fronthaul link of a cell-free distributed massive MIMO network and of the role played by each of the access points, according to the present invention, of the plurality of access points in series that compose such a fronthaul link.

More precisely, the time-division duplex technique (TDD) separates transmissions of the downlink (DL) communication channel from the transmission of the uplink (UL) communication channel according to the assumption of perfect reciprocity of the channels, which can be provided by precise calibration methods known to a person skilled in the art. In addition, the transmission of a frame according to the TDD technique within a CF-mMIMO-OFDM network is implemented within the coherence time and the width of the physical resource block (RB) is less than the coherence bandwidth.

Thereafter, to comply with the standard 5G NR, a radio frame the time-frequency resource of which is divided into N resource blocks RB, will be considered in particular. Each resource block comprises

$${N}_{sc} = \frac{N}{{N}_{rb}}$$

consecutive subcarriers. The resource unit (RU) is denoted by (t,n)_{l,m}, which represents the smallest time-frequency resource of the n^{th} subcarrier of the t^{th} OFDM symbol corresponding to the m^{th} antenna of the l^{th} access point.

For example, such a TDD frame conventionally comprises N₀ OFDM symbols, which corresponds to the shortest coherence interval of all users, and to the transmission of: τ_{c}=N_{sc}N_{c} resource units RU per resource block RB, where τₚ resource units among the τ_{c} resource units are used as pilots which are distributed within the transmission payload on the uplink communication channel UL. Such pilots are conventionally used in particular to estimate M×K channels in the frequency domain, per resource block, within each access point. Thus, N_{D}=N_{sc}N_{c}−τₚ resource units are reserved per resource block, for the useful data in the samples, which are divided between the transmissions of the downlink communication channel DL and the data of the uplink communication channel UL into two complementary parts εN_{D} and (1−ε)N_{D}, respectively, with 0<ε<1.

More precisely, in FIG. 3, two embodiments A and B of fronthaul links are shown, a fronthaul link corresponding, by definition according to the present invention, to the link for interconnecting the access points with the central processing unit 62 of a base station 64, so as to correct step-by-step, via said fronthaul link, the signal distortion caused by the hardware impairments of each access point during the implementation of the communication on the downlink communication channel DL of the cell-free distributed massive MIMO network.

In FIG. 3, according to the embodiment A, the fronthaul link has one end consisting of an access point 10₁ and another end consisting of the central processing unit 62 of the base station 64, the L access points 10₁, 10₂, 10₃ . . . , 10_{L} forming same being in series, ordered along a predetermined direction 66 of travel of said fronthaul link to the central processing unit 62 of the base station.

According to the embodiment B, the fronthaul link forms a framework around K users, e.g. K=6 for the users illustrated by the terminals p1, p2, p3, p4, p5, p6 arbitrarily distributed within the coverage area, and also comprises L access points, such as L>>K, in series, ordered along a predetermined direction 68 of travel of said fronthaul link starting e.g. with the access point 10₁, then 10₂, 10₃, . . . , up to the access point 10_{L} and then the central processing unit 62 of the base station (it should be noted that in another case the direction 68 could be reversed).

It should be noted that in general, a CF-mMIMO network is suitable for being divided into a plurality of fronthaul links (i.e. segments) corresponding to access points linked in series via a fronthaul link, and the processing is applied for each segment, e.g. a segment according to the embodiment A and/or a segment according to the embodiment B independently from one segment to another, or according to any other known network topology.

The signal received at the k^{th} user via the n^{th} subcarrier is expressed in particular in the following form:

$${y}_{k , n} = {\sum }_{l = 1}^{L} {h}_{l , k , n}^{H} {z}_{l , n} + {b}_{k , n} = {\sum }_{l = 1}^{L} {h}_{l , k , n}^{H} {K}_{0} {x}_{l , n} + {\sum }_{l = 1}^{L} {h}_{l , k , n}^{H} {d}_{l , n} + {b}_{k , n} \qquad ( 5 )$$

where z_{l,n}ϵ [symbol] ^{M×1} is the amplified signal, expressed in the frequency domain, transmitted by the access point with index L on the sub-carrier n, d_{l,n}ϵ [symbol] ^{M×1} is the signal distortion (i.e. the distortion noise) caused by hardware impairments, K₀ is the diagonal matrix M×M whose elements are equal to K₀ as introduced hereinabove, b_{k,n}˜CN (0,1) and is a Gaussian noise, the random variables of which are independent and identically distributed (i.e. i.i.d).

Moreover, per resource block and per user, the spectral efficiency SE is suitable for being calculated as described by W. Jiang in the article “Cell-Free Massive MIMO-OFDM Transmission Over Frequency-Selective Fading Channels” IEEE Communications Letters, vol. 25, no. 8, pp. 2718-2722, 2021 in the form

$${SE}_{k} = ξ ( 1 - \frac{{τ}_{p}}{{N}_{sc} {N}_{c}} ) {N}_{sc} Δ f {log}_{2} ( 1 + SIN {R}_{k , n} ) \qquad ( 6 )$$

with SINR_{k,n} the Signal-to-interference-Plus-Noise Ratio of the k^{th} user, by using the subcarrier n expressed in the following form:

$$SIN {R}_{k , n} = \frac{{\vert {\sum }_{l = 1}^{L} \sqrt{{η}_{l , k}} 𝔼 \{ {h}_{l , k , n}^{H} {K}_{0} {w}_{l , k , n} \} \vert}^{2}}{\begin{matrix}{\sum }_{t = 1}^{K} 𝔼 \{ {\vert {\sum }_{l = 1}^{L} \sqrt{{η}_{l , t}} {h}_{l , k , n}^{H} {K}_{0} {w}_{l , n , t} \vert}^{2} \} - \\ {\vert {\sum }_{l = 1}^{L} \sqrt{{η}_{l , k}} 𝔼 \{ {h}_{l , k , n}^{H} {K}_{0} {w}_{l , k , n} \} \vert}^{2} + {Ψ}_{k , n} + 1\end{matrix}}$$

with:

$${Ψ}_{k , n} = 𝔼 \{ {\vert {\sum }_{l = 1}^{L} {h}_{l , k , n}^{H} {d}_{l , n} - {\sum }_{l = 1}^{L - 1} {C}_{l}^{′} {h}_{l + 1 , k , n}^{H} {w}_{l + 1 , k , n} {\hat{h}}_{l , k , n}^{H} {d}_{l , n} \vert}^{2} \}$$

and Cₗ′ is a normalization factor.

As indicated hereinabove in relation to FIGS. 1 and 2, the access points adapted (i.e. modified) according to the present invention and connected in series via a fronthaul link, provide considerable capacities of limitation (i.e. reduction) in the event of severe, or even, advantageously, of cancellation (or compensation) of the physical impairments caused by each access point of the fronthaul link considered, the impairments being largely caused by the power amplifiers 58 and digital-to-analog converters 54 of each transmission chain associated with each transmitter 56 of each access point 10 as illustrated hereinabove in relation to FIG. 2.

FIG. 3 illustrates more precisely the information item transmitted on each fronthaul segment, allowing signal distortions caused by the hardware impairments of each access point, to be limited or even removed step-by-step along the fronthaul link.

More precisely, according to the present invention, it is first of all considered that, conventionally, each access point locally calculates local channel estimations from the pilot sequences transmitted by each user, and uses same specifically according to the present invention, for precoding the data useful to the users served, in such a way that the signals transmitted by all the access points are constructively added at the antennas of the user terminals, and thereby limiting, or even canceling, signal distortions caused by the hardware impairments of each access point.

In other words, as illustrated in FIG. 3, the present invention exploits the serial architecture of the serial fronthaul link (i.e. segment) to implement a limitation (in the event of severe hardware impairments), or even a removal of signal distortions caused by the hardware impairments of each access point.

In the examples of fronthaul segments A and B of FIG. 3, the first access point 10₁ of the fronthaul link along a predetermined direction of travel 66 or 68 to the central processing unit 62 first determines, conventionally, local precoding filters based on (i.e. using) the local channel estimates between the first access point 10₁ and each user k, each illustrated e.g. by the terminals using the pilots p1, p2, p3, p4, p5, p6 shown in FIG. 3.

As indicated hereinabove, the local precoding filters are MRT, FZF or RZF filters, the vector precoded in the frequency domain suitable for being transmitted, by radio, by the access point with index l on the sub-carrier with index n being, as indicated hereinabove, expressed in the following form: x_{l,n}=W_{l,n}Pₗsₙ.

Then, as indicated above in relation to FIGS. 1 and 2, the first access point 10₁ is also suitable, specifically according to the present invention, for approximating (i.e. determining) the signal distortion caused by the own hardware impairments thereof {d_{1,n}, ∀n}, the distortion d_{1,n} being de facto also transmitted by the first access point 10₁, by radio, to each user k.

On the user side, the signal distortions caused by the own hardware impairments of the first access point 10₁, actually received after the frequency domain precoded signals {x_{1,n}, ∀n} have been generated, modulated, and have passed through each radio frequency chain of the first access point and then transmitted through the user channels, may be expressed in the form {Ĥ_{1,n}^{H}d_{1,n}, ∀n}, and as illustrated in FIG. 3, in particular on the fronthaul segment of type A, the first access point 10₁ transmitting the signal distortions {Ĥ_{1,n}^{H}d_{1,n}, ∀n} to the next access point 10₂ along the direction 66 of travel of said fronthaul link, via said fronthaul link. The transmission module 14 and reception module 16 mentioned hereinabove with reference to FIG. 1 are thus-transmission and/or reception modules via the fronthaul link and not via a radio channel such as the link used to communicate with the users. In other words, advantageously, K complex samples for each sub-carrier of index n, will be transmitted by the first access point 10₁ to the second access point 10₂, using the fronthaul segment.

Then, when the access point with index l, l∈[1,L], e.g. l=2 for the second access point 10₂, receives, via the fronthaul link, the signal distortions {Ĥ_{l-1,n}^{H}d_{l-1,n}, ∀n} received on the user side from the previous access point with index l−1, along the fronthaul serial link, the access point of index l uses the information item {Ĥ_{l-1,n}^{H}d_{l-1,n}, ∀n} in conjunction with the own local channel estimations {Ĥ_{l,n}^{H}, ∀n} thereof, to determine the local precoding filters thereof, so that the latter can make possible, on the side of the K users, a coherent construction of the effective signals while removing the signal distortions caused by the hardware impairments of the access point of index l−1 preceding it.

Thereby, the optimal precoded signals x_{l,n} in the frequency domain suitable for being transmitted by the l^{th} access point on the subcarrier n to the K users are expressed by the unique solution: x_{l,n}=W_{l,n}Pₗsₙ−W_{l,n}Cₗ′Ĥ_{l-1,n}^{H}d_{l-1,n} where Cₗ′ϵ [symbol] ^{K×K} is a normalization matrix satisfying {E{∥Ĥ_{l,n}^{H}w_{l,n}∥²}=Iₖ, ∀k} that can be optimized by means of an optimal diagonal matrix, the elements of which are

$$\frac{1}{\sqrt{( M - K ) {β}_{l , k}}} , k = 1 , … , K .$$

As shown in FIG. 3, the l^{th} access point, e.g. for l=2, the second access point 10₂, in turn transmits, via the fronthaul link, the signal distortions actually received by the K users and caused by the own impairments thereof expressed in the form {Ĥ_{l,n}^{H}d_{l,n}, ∀n}, (which amounts to {Ĥ_{2,n}^{Hd}₂d_{2,n}, ∀n} for the second access point 10₂ of index l=2) at the access point of index l+1, e.g. for l=2, the access point 10₃ of index l+1=3, and so on repeated in series (i.e. step-by-step) along the fronthaul link until reaching the central unit 62.

According to the present invention, the central unit 62 of a base station 64 of a cell-free distributed massive MIMO network, associated with at least one fronthaul link comprising a plurality of access points in series, such as described hereinabove with reference to FIGS. 1 and 2, and ordered along a predetermined direction of travel of said fronthaul link to said central unit, further comprises, specifically according to the present invention, at least one reception module configured to receive, via said fronthaul link, an information item representative {Ĥ_{L-1,n}^{H}d_{L-1,n}, ∀n} of a signal distortion caused by hardware impairments of access point of index l−1 directly preceding it within said fronthaul link, and to take into account said information item so as to determine the local precoding filters of said central unit configured so as to make possible, on the side of the K users, a coherent construction of the effective signals {sₙ} ∀n while suppressing, said signal distortion {Ĥ_{L-1,n}^{H}d_{L-1,n}, ∀n} caused by hardware impairments of said access point of index l−1 preceding it.

Thereby, the central processing unit 62 of the base station (or the last access point in the fronthaul link) contributes to the compensation for the distortions generated by the predecessor access point.

With regard to the distortion generated by the base station 64 as such, it should be noted that, according to a first variant, the distortion generated by the base station 64 as such is considered acceptable as the distortion has little impact on the overall performance of the system, or according to a second variant, where because the equipment used in the base station is more efficient (more expensive and more energy consuming), the distortion generated by the base station 64 as such is also considered to be negligible.

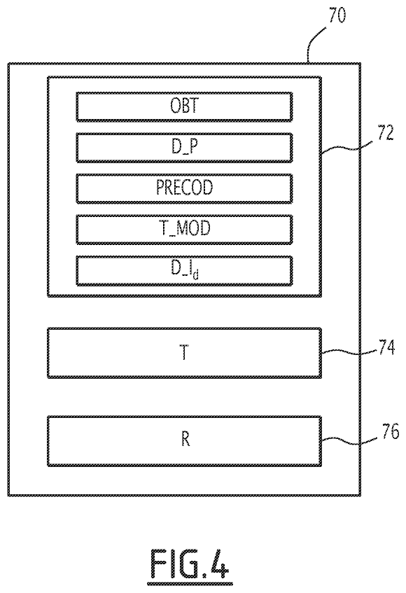

An example of an embodiment of the operation, according to the present invention, of an access point of a fronthaul link of a free-cell distributed massive MIMO network according to the present invention, is described hereinafter with reference to FIG. 4.

More specifically, the method 70 of limiting the signal distortion caused by hardware impairments of a plurality of access points of a fronthaul link of a cell-free distributed massive MIMO network is implemented by each access point of said fronthaul link or by said central unit, and implemented during communication on the downlink communication channel of said cell-free distributed massive MIMO network.

The method 70 comprises, when it is implemented by each access point 10₁ to 10_{L-1} of said fronthaul link, first of all a step 72 of determining an information item representative of a signal distortion caused by the own hardware impairments of said access point.

In addition, when the method 70 is implemented by each access point 10₁ to 10_{L-1} of said fronthaul link, the method further comprises a step 74 of transmission T, via said fronthaul link, of said information item representative of said signal distortion caused to another access point, or to the central processing unit of a base station, directly following it within a fronthaul link comprising a plurality of access points in series, ordered along a predetermined direction of travel of said fronthaul link.

Finally, when the method 70 is implemented by each access point of said fronthaul link, with index 2≤l≤L−1 10₂ to 10_{L-1}, or when same is implemented by the central processing unit 62 (last access point in the fronthaul link), the method 70 further comprises a step 76 of receiving R, via said fronthaul link, and taking into account said information item representative of a signal distortion caused by the hardware impairments of an access point directly preceding it within said fronthaul link, so as to determine the local precoding filters of said access point or said central unit configured to cancel said distortion signal caused by hardware impairments of the access point preceding it.

As an optional addition, as illustrated by the example shown in FIG. 4, said determination step 72 comprises obtaining OBT a local estimation of the propagation channel between each of the transmitters thereof and each user terminal within the range thereof within said cell-free distributed massive MIMO network.

Moreover, said determination step 72 comprises the determination D_P of the power allocated to each data signal suitable for being transmitted between said access point and each user terminal within the range thereof within said cell-free distributed massive MIMO network.

Furthermore, said determination step 72 comprises the precoding PRECOD of each data signal suitable for being transmitted between each of the transmitters thereof and each user terminal within the range thereof within said cell-free distributed massive MIMO network, based on said associated local estimation and said allocated power.

Said determination step 72 further comprises the transmission T_MOD of each precoded signal at the input of a hardware model of the transmission chain of the associated transmitter thereof.

Finally, said determination step 72 comprises the determination D_I_{d} of said information item representative of the signal distortion caused by the own hardware impairments of said transmitter by comparing the output of said material model and of said input precoded signal.

A person skilled in the art would understand that the invention is not limited to the embodiments described, nor to the particular examples of the description, the above-mentioned embodiments and variants being suitable for being combined with one another so as to generate new embodiments of the invention.

The present invention thereby proposes an efficient solution for distributed/cell-free MIMO technologies which are currently the most promising technologies for supporting the future of Industry 4.0 wherein private/industrial networks and applications with rapid deployment of wireless access infrastructure and low energy consumption are important issues.

The sequential processing proposed according to the present invention, by using the fronthaul link, takes advantage of the serial connections of such fronthaul link, and the latest advances in distributed precoding schemes thereby providing radical performance improvements in mitigating hardware impairments of each access point of said fronthaul link, which makes the implementation of cell-free distributed massive MIMO networks, practical and useful using in particular multi-carrier modulation, in particular OFDM, such networks being known by the abbreviated name CF-mMIMO-OFDM.

Finally, the present invention aims at responding at least in part to the high demand for “green” signal processing solutions due to concerns related to the sustainability of the telecommunications sector and, correspondingly, to the reduction of associated carbon dioxide emissions, which would save energy and reduce environmental pollution.

1. An access point of a cell-free distributed massive MIMO network, wherein it comprises at least:
a determination module configured to determine an information item representative of signal distortion caused by the own hardware impairments of said access point,
a transmission module configured to transmit, via a fronthaul link comprising a plurality of access points in series ordered along a predetermined direction of travel of said fronthaul link to the central unit of a base station, said information item representative of said signal distortion to another access point, or to the central unit, directly following it within said fronthaul link;
a reception module configured to receive, via said fronthaul link, said information item representative of a signal distortion caused by the hardware impairments of an access point directly preceding it within said fronthaul link, and to take into account the information item so as to determine the local precoding filters of said access point configured to cancel said signal distortion caused by the hardware impairments of said access point preceding it.

2. The access point according to claim 1, wherein to determine said information item representative of signal distortion, said access point determination module is configured to:
obtain a local estimation of the propagation channel between each of the transmitters thereof and each user terminal within the range thereof within said cell-free distributed massive MIMO network,
determine the power allocated to each data signal suitable for being transmitted between that access point and each user terminal within the range thereof within said cell-free distributed massive MIMO network,
precode each data signal suitable for being transmitted between each of the transmitters thereof and each user terminal within the range thereof within said cell-free distributed massive MIMO network based on said associated local estimation and on said allocated power;
transmit each precoded signal as input to a hardware model of the transmission chain of the associated transmitter thereof;
determine said information item representative of the signal distortion caused by the own hardware impairments of the transmitter, by comparing the output of said hardware model and said input precoded signal.

3. The access point according to claim 2, wherein said hardware model of the transmission chain of each transmitter is modeled using at least one predetermined measurement and/or a predetermined optimization.

4. The access point according to claim 1, wherein it comprises a plurality of simultaneously active transmitters, said information item representative of a signal distortion caused by the own hardware impairments corresponding to the concatenation of the signal distortion caused by the own hardware impairments of each of the transmitters of said plurality.

5. The access point according to claim 2, wherein the transmitter is an OFDM transmitter.

6. The access point according to claim 1, wherein each local precoding filter is a MRT, FZF or RZF filter.

7. A central unit of a base station of a cell-free distributed massive MIMO network, said central unit being associated with at least one fronthaul link comprising a plurality of access points in series, according to claim 1, and ordered along a predetermined direction of travel of said fronthaul link to said central unit,
wherein said central unit of a base station comprises at least one reception module configured to receive, via said fronthaul link, an information item representative of signal distortion caused by hardware impairments of an access point directly preceding it within said fronthaul link, and to take into account said information item so as to determine the local precoding filters of said central unit configured to cancel said signal distortion caused by the hardware impairments of said access point preceding it.

8. A cell-free, distributed bulk MIMO network comprising at least one fronthaul link, wherein said at least one fronthaul link comprises a plurality of access points in series, according to claim 1, and ordered along a predetermined direction of travel of said fronthaul link.

9. A method of limiting the signal distortion caused by hardware impairments of a plurality of access points of a fronthaul link of a cell-free distributed massive MIMO network, said plurality of access points being connected in series along said fronthaul link to the central unit of a base station and ordered along a predetermined direction of travel of said fronthaul link, said method being implemented by each access point of said fronthaul link or by said central unit, and implemented during the communication on the downlink communication channel of said cell-free distributed massive MIMO network, said method comprising at least the following steps:
determination of an information item representative of a signal distortion caused by the own hardware impairments of the access point, and
transmission, via said fronthaul link, of said information item representative of said signal distortion caused to another access point, or to the central unit of a base station, directly following it within a fronthaul link comprising a plurality of access points in series, ordered along a predetermined direction of travel of said fronthaul link; and
or:
determination of an information item representative of a signal distortion caused by the own hardware impairments of the access point, and
transmission, via said fronthaul link, of said information item representative of said signal distortion caused to another access point, or to the central unit of a base station, directly following it within a fronthaul link comprising a plurality of access points in series, ordered along a predetermined direction of travel of said fronthaul link; and
reception, via said fronthaul link, and taking into account an information item representative of a signal distortion caused by the hardware impairments of an access point directly preceding it within said fronthaul link so as to determine the local precoding filters of said access point or of said central unit configured to cancel said distortion signal caused by hardware impairments of the access point preceding it,
or:
reception, via said fronthaul link, and taking into account an information item representative of a signal distortion caused by the hardware impairments of an access point directly preceding it within said fronthaul link so as to determine the local precoding filters of said access point or of said central unit configured to cancel said distortion signal caused by hardware impairments of the access point preceding it.

10. The method according to claim 9, wherein said determination of an information item representative of signal distortion caused by said own hardware impairments of said access point comprises:
obtaining a local estimate of the propagation channel between each of the transmitters thereof and each user terminal within the range thereof within the said cell-free distributed massive MIMO network,
the determination of the power allocated to each data signal suitable for being transmitted between said access point and each user terminal within the range thereof within said cell-free distributed massive MIMO network,
the precoding of each data signal suitable for being transmitted between each of the transmitters thereof and each user terminal within the range thereof within said cell-free distributed massive MIMO network based on said associated local estimation and allocated power;
the transmission of each precoded signal at the input of a hardware model of the transmission chain of the associated transmitter thereof;
the determination of said information item representative of the signal distortion caused by the own hardware impairments of the transmitter, by comparing the output of said hardware model and said input precoded signal.

11. A computer program including software instructions which, when executed by a computer, implement a method of limiting signal distortion caused by hardware impairments of a plurality of access points of a fronthaul link of a cell-free distributed massive MIMO network according to claim 9.
